(19) United States
(12) Patent Application Publication
(10) Pub. No.: US 2013/0306793 A1
(43) Pub. Date: Nov. 21, 2013

(54) Fuselage Segment For A Fuselage Of An Aircraft, Aircraft Fuselage and Aircraft

(71) Applicant: Airbus Operations GmbH, Hamburg (DE)

(72) Inventors: Johann Konrad Erben, Hamburg (DE); Sten Kramer, Freital (DE)

(73) Assignee: AIRBUS OPERATIONS GMBH, Hamburg (DE)

(21) Appl. No.: 13/954,240

(22) Filed: Jul. 30, 2013

Related U.S. Application Data
(63) Continuation of application No. PCT/EP2012/051142, filed on Jan. 25, 2012.
(60) Provisional application No. 61/437,878, filed on Jan. 31, 2011.

(30) Foreign Application Priority Data
Jan. 31, 2011 (DE) 10 2011 009 806.2

(51) Int. Cl. B64C 1/22; B64D 11/00

(52) U.S. Cl. CPC B64C 1/22; B64D 11/00
USPC 244/118.1

(57) ABSTRACT

A fuselage segment for an aircraft fuselage includes a wall with a closed cross section, a first cabin floor, a second cabin floor, and a cargo hold floor. The first cabin floor, the second cabin floor, and the cargo hold floor are vertically spaced apart from each other and connected to the wall. A first passenger region is arranged above the first cabin floor, a second passenger region is arranged above the second cabin floor, and a cargo region is arranged above the cargo hold floor. The cargo region is dimensioned in such a manner that for at least four passenger seats a maximum of 1 m³ of cargo hold volume is provided. In this manner an existing aircraft fuselage can be designed in a demand-oriented manner so that it can accommodate two or more passenger regions.

### CROSS-REFERENCE TO RELATED APPLICATIONS

The present application is a continuation of International Application No. PCT/EP2012/051142, filed Jan. 25, 2012, which claims priority from German Patent Application No. 10 2011 009 806.2 filed Jan. 31, 2011 and claims the benefit of the filing date of of United States Provisional Patent Application No. 61/437,878 filed Jan. 31, 2011, the disclosures of which are hereby incorporated herein by reference.

### TECHNICAL FIELD

The invention relates to a fuselage segment for a fuselage of an aircraft, to an aircraft fuselage comprising a fuselage segment, and to an aircraft.

### BACKGROUND TO THE INVENTION

The number of passengers that can be transported in a commercial aircraft is usually limited by the outer shape of the aircraft fuselage, which shape accommodates both a passenger cabin and a cargo region. The cargo region comprises an adequate volume for accommodating baggage, and in some instances also cargo containers.

Furthermore, an increase of passenger capacity in present-day aircraft is achieved only if the fuselage diameter is increased or if the cross-sectional shape is changed from a circular shape to an oval or elliptical shape. Accordingly, this is only possible if changes are made to the basic design of the aircraft fuselage.

DE 4 416 506 and DE 4 116 524 show aircraft fuselages comprising several decks.

### BRIEF SUMMARY OF THE INVENTION

It can thus be considered to be an aspect of the invention to propose a fuselage segment with a larger capacity for accommodating passengers without there being a need to fundamentally change the design of the fuselage cross section. In particular, it can be considered to be an aspect of the invention to design a fuselage cross section of an existing fuselage of an aircraft in such a manner that a maximum number of passengers can be transported.

An aspect of the present invention includes the needs-optimized use of a predetermined volume of a fuselage segment by a corresponding design that is exclusively controlled by the realistic need for stowage space for the passengers' baggage. In this arrangement the fuselage segment is, however, not to be designed so as to be variable, i.e. flexible, so that fixed passenger regions and a fixed cargo region are to be provided that are not to be equipped with different quickly-deployable space utilization modules. In this arrangement the concrete design of the fuselage segment according to an aspect of the invention takes place while adhering to defined boundary conditions which apart from certification requirements relating to passenger aircraft also contain global parameters such as the fuselage diameter and the space requirement of systems necessary for flight operation.

Basically, the fuselage segment according to an embodiment of the invention comprises a first cabin floor and a second cabin floor spaced apart from each other in vertical direction and connected to a wall of the fuselage segment. In this arrangement the first cabin floor can, as an example, be affixed above the second cabin floor, and can together with the wall form a first passenger region. The underlying section between the first cabin floor and the second cabin floor, delimited by the wall of the fuselage segment, forms the second passenger region. A cargo hold floor is arranged vertically spaced apart from the passenger floors, and together with adjoining walls said cargo hold floor forms a cargo region. Apart from these three regions, furthermore, there is a system region that is used to accommodate systems necessary for operating the aircraft, which system region can, however, not be designed according to needs, but with a constant fuselage segment diameter must remain practically unchanged.

This imperatively results in the number of passengers that can be accommodated being able to be altered only when the ratio of the overall volume of all passenger regions to the volume of the cargo region is brought to a level that corresponds to needs, so that frequently existing but superfluous stowage volume in the cargo region can practically be completely done without and can be made useable in the form of volume for a passenger region.

In existing aircraft with the usual 2-class or 3-class seat arrangement, passengers in economy class can on average carry a cabin baggage volume of 0.11 m³. In business class or first class, present day aircraft allow for an average cabin baggage volume of 0.202 m³ per passenger in the cabin. Depending on the respective aircraft operator, peak values of 0.24 m³ baggage volume per passenger in a distinctly comfortable cabin layout in a large fuselage segment are achieved. For checked baggage of passengers, which baggage is accommodated in the cargo region, an average baggage volume of 0.24 m³ per passenger is available. A division according to comfort classes does not make sense because the baggage is not accommodated in separate spaces. However, these values compare with a different actual use in flight operation, which use can significantly be determined as being limited by the specifications, issued by the aircraft operator, relating to the allowed number of items of baggage per passenger, their dimensions and, in the context of the flight performance, by the allowed baggage weight per passenger. An analysis shows that aircraft with relatively large stowage space, with the same key data relating to the allowed passenger baggage, manage to achieve inferior space utilization when compared to aircraft with little stowage space. This category includes above all aircraft with a very small fuselage diameter, which aircraft are as a rule used in short-haul flights. However, even if all the passengers were to take along the maximum allowed quantity of baggage, all the medium-range and long-range aircraft have a generous reserve in terms of both volume and weight.

Within the framework of the following description this context is expressed by means of a measured value comprising the number of passengers per m³ of cargo volume [PAX/m³], which presently with common medium-range and long-range aircraft attains a value of 2:1 to 3:1. The cargo hold volume that remains after stowage of the passenger baggage is frequently filled with cargo if operation of the aircraft with an empty cargo hold appears to be uneconomical.

Thus aspects of the present invention are based on the analysis that in an aircraft, in particular in so-called wide-body types with two aisles in the passenger cabin, which aircraft are used for medium-range and long-range flights and provide more cargo space than is necessary for pure passenger transport, even with extremely generous interpretation and utilization of the boundary conditions established by the aircraft operators said cargo space would not be fully used.

According to an embodiment of the invention, the cargo hold volume per passenger seat, which cargo hold volume is provided by the cargo region, is at most 0.25 m³. This means that the above-mentioned measured value [PAX/m³] is 4:1 or higher, which allows adequate accommodation of items of baggage with an average baggage volume of passengers, while not resulting in too large a cargo hold volume that would then have to be filled with cargo.

In the design of such a fuselage segment according to an embodiment of the invention the space required by aircraft systems needs adequately to be taken into consideration. Without in any way claiming to be exhaustive, this includes the space required by all the electronic and mechanical components, arranged in the fuselage, of air control systems, a fuel system, an air conditioning system, an on-board entertainment system (“in-flight entertainment system”), and numerous further systems. The space required for accommodating the landing gear and the corresponding associated landing gear mechanism, as well as the corresponding flaps of the landing gear must also be taken into account. In order to accommodate the landing gear attached to the fuselage or retracting into the fuselage, a cargo region situated on a lower end of the fuselage segment could be interrupted at the position concerned.

According to an advantageous embodiment the cargo region comprises an available cargo volume that is smaller than the volume corresponding to the maximum volume of baggage relating to all passenger seats. In practical application neither in the short-haul segment nor in the medium-haul segment are there exclusively passengers with a maximum quantity of baggage on board; good utilization of the cargo volume is achieved only in charter operations, in the case of destinations where a lot of special baggage (diving equipment, surfboards and the like) is involved, in combination with a very tight seat arrangement and full capacity utilization, i.e. the maximum possible number of passengers. However, in the vast majority of flight operations there is presently almost no chance of the cargo hold being fully taken up by passenger baggage. On average, the required volume is approximately 70% of the maximum volume, which would approximately equate to 0.165-0.170 m³ per passenger seat.

In a preferred embodiment of the invention the fuselage segment comprises a diameter ranging from 6-6.5 m. Assuming that all passengers utilize the respective maximum of an available personal cargo volume, a critical value of 6-6.5 m relating to a fuselage diameter results, from which value onwards as a result of a corresponding reduction in the cargo volume a second passenger deck can be incorporated. The precise value to be selected depends on the minimum of comfort that is to be achieved in the passenger cabin, and on the cargo volume that is to be assumed for the design. In the case of a ratio of passenger to baggage volume [PAX/m³] of 4:1, due to the necessary size and thus the height of the cargo region a larger diameter would be necessary than would be the case, for example, with a ratio of 5:1.

A reduction in the fuselage diameter to below 6 m could lead to a situation in which the edge regions within the aircraft fuselage in a cabin floor arranged on an upper region of a fuselage segment could not be fully utilized by passenger seats because the distance between the wall of the fuselage segment and the outermost passenger seats would have to be too great. A respective investigation during the design phase requires an impact circle or movement circle of the head of a passenger (the so-called “head strike radius”) not to comprise any components that could result in head injuries. Thus at the design stage of the cabin a head strike radius is drawn around the head of each passenger in their associated seat positions, wherein none of these head strike radii must intersect any cabin installations, paneling elements or the like. In the case of passenger seats that are installed on the edge in the upper region of a fuselage, accordingly quite a sizeable distance to the fuselage inner wall or to the interior lining must be maintained.

Such a fuselage diameter provides a special advantage in that already existing medium-range and long-range aircraft, for example of the type AIRBUS A350® XWB with a fuselage width of 5.96 m and a fuselage height of 6.09 m, can provide adequately large fuselage segments that can be used for redesign with more than just one cabin floor without this requiring the design of an entirely new aircraft. In this example, offsetting a cabin floor, which is presently arranged in vertical direction approximately in the center, in vertical direction (along the vertical axis of the fuselage segment) downwards to limit the cargo hold, and incorporating a second cabin floor above the normal installation position of the usually present cabin floor of an aircraft can result in the creation of an aircraft with significantly increased passenger capacity.

In an advantageous embodiment of the invention the fuselage segment comprises an almost circular cross section. In the state of the art, for example, two-storey passenger cabins are known only from aircraft comprising an oval or elliptical cross section (e.g. AIRBUS A380®) or partial cross section (e.g. BOEING 747®) so that a corresponding design height can be achieved without increasing the fuselage width, while achieving at the same time a large cargo volume. An almost circular cross section of the fuselage segment according to the invention could result in reduced aerodynamic resistance when compared to that of known fuselage shapes with a two-storey cabin, wherein the passenger capacity is, however, comparable.

It should be noted that it is not mandatory for such an “almost circular” cross section to be completely ideally circular in design, because in the state of the art it is not unusual for a fuselage segment to be comprised of several sections of fuselage skins that comprise different curvatures and that as designs are also based on the double lobe, triple lobe/3 lobe, quadruple lobe/4 lobe, 5 lobe, etc. principle. These curvatures are within quite a similar range and are usually designed in the manner of segments of a circle, and consequently, when viewed from a distance the fuselage cross section is perceived to be circular. The subject-matter of the invention is thus not limited to a complete ideally circular cross section, but instead can also comprise the modifications, situated within the usual framework, relating to the adaptation of local radii of curvature that result in tangentially adjoining curved sections of fuselage skin.

In an advantageous embodiment of the invention each of the individual passenger regions comprises a standing height of at least 1.95 m. This makes it possible for passengers to move comfortably within the individual passenger regions, while it can at the same time limit the vertical extension of the passenger cabin to such an extent that integration of two passenger decks in a long-range aircraft or a medium-range aircraft becomes possible.

In an equally advantageous embodiment of the invention the first passenger region is arranged in an upper region of the fuselage segment and comprises lateral stowage compartments for accommodating cabin baggage, which stowage compartments are arranged between the outer passenger seats and the fuselage inner wall.

At this point it should furthermore be pointed out that it is not mandatory for the vertical arrangement of the passenger regions and of the cargo region to be selected in the manner that would appear customary in presently used commercial aircraft. For example, the cargo region could be situated above a passenger region, for example if as a result of a relatively small fuselage diameter and thus a large necessary space to the fuselage inner wall it would not be advantageous to arrange passenger seats in an upper region of the fuselage. If this position is designed as a cargo region, there would be considerably fewer geometric requirements.

Furthermore, in an advantageous embodiment, sections of a passenger region can also be divided by a cargo region, for example above a wing box or a landing gear well or the like, where locally an arrangement of passenger seats does not appear sensible. At the same time this can also result in a further reduction in the height of a cargo region.

Furthermore, it is imaginable to also create a fuselage segment according to the invention that is based on an oval fuselage. For example, the aircraft of the type A380 with a fuselage width of 7.14 m and a fuselage height of 8.69 m provides quite a large cross sectional area with a nevertheless limited fuselage width as a result of its oval shape. The concept according to the invention can be transposed to a fuselage shaped in this manner, in that the cargo volume is significantly reduced and at the same time an additional cabin floor is installed. In this way it would be possible to obtain an aircraft with three passenger decks and a demand-oriented cargo region.

As an alternative to the above, the fuselage segment according to an embodiment of the invention could also comprise a cross section in the form of a so-called “double bubble” in which two cross-sectional halves, which at least in part are in the shape of a segment of a circle, as a result of a constriction are in the shape of the figure eight. At the constriction point it would be possible, for example, to arrange a cabin floor that could be designed in such a manner that it comprises adequate tensile strength to accommodate pressure-induced tensile forces.

At the same time, with enlargement of the diameter of an almost circular fuselage cross section it would also be imaginable to provide a third cabin floor. The diameter of such a fuselage segment according to the invention with three cabin regions would be approximately 7.5 m; it can range from 7 m to 8 m and would preferably range from 7.25 m to 7.75 m.

In summary, the method for designing a fuselage segment according to an embodiment of the invention is in principle based on the interaction of the concrete volume provided in the fuselage, the passenger-dependent specifications and regulations of the aircraft operator, the measurements of suitable items of baggage, and the statistical investigation of quantities of baggage that at present are typically carried. This results in a scenario with maximum possible and allowed baggage per passenger (mass, dimensions, total volume and number of items), differentiated between checked baggage or hold baggage and cabin baggage. In future space-concepts of aircraft fuselages current standards should be maintained or improved if at all possible. This also relates to the options of passengers being able to stow their baggage on board themselves. From the aforesaid a maximum requirement relating to baggage in the cabin of the aircraft and in a cargo region can be determined depending on the number of passengers transported. This is followed by optimization of the design of the cabin by optimizing the existing volume, which is implemented, for example, by preparing various possible cabin layouts and their subsequent comparison relating to passengers that can be transported. All the steps are carried out taking into account all the safety regulations and rules. Apart from the normal design guidelines relating to the cabin this also relates to the number and distribution of doors, stairs and emergency exits so that evacuation of the aircraft concerned can be achieved within a prescribed period of time. There is no need for any restriction to two or three cabin floors; in principle and depending on the fuselage size, it is also possible to incorporate a greater number of cabin floors.

An aspect of the present invention can also be used to design an aircraft with a relatively small cross section, which aircraft comprises a cargo region that has been designed in a demand-oriented manner, and which aircraft comprises only a single cabin floor and thus also only a single passenger region. This means that such an aircraft can be entirely redesigned with the above-mentioned approach. In this way it would be possible to design, for example, short-range and medium-range aircraft with a fuselage that is designed so as to be aerodynamically more favorable when compared to that of short-range and medium-range aircraft according to the state of the art.

Other embodiments of the present invention include a fuselage for an aircraft, as well as an aircraft comprising such a fuselage, which fuselage has been designed according to the aspects of the invention or has been selected from a number of already known aircraft fuselages.

### BRIEF DESCRIPTION OF THE DRAWINGS

Further characteristics, advantages and application options of the present invention are disclosed in the following description of the exemplary embodiments and the figures. All the described and/or illustrated characteristics per se and in any combination form the subject of the invention, even irrespective of their composition in the individual claims or their interrelationships. Furthermore, identical or similar components in the figures have the same reference characters.

FIG. 1 shows a diagrammatic view of a cross section of a fuselage segment according to the state of the art.

FIG. 2 shows a diagrammatic view of a fuselage cross section according to an embodiment of the invention.

FIGS. 3a and 3b each show a section view of an aircraft fuselage according to an embodiment of the invention with a cabin layout for a first and a second passenger region.

FIG. 4 shows an exemplary embodiment of a fuselage segment according to the invention with mixed seating.

FIG. 5 shows an exemplary embodiment of a fuselage segment according to the invention with mixed seating.

FIG. 6 shows an exemplary embodiment of a fuselage segment according to the invention with uniform seating.

FIG. 7 shows an exemplary embodiment of a fuselage segment according to the invention with a ceiling-height stowage cabinet.

FIG. 8 shows a further exemplary embodiment of a fuselage segment according to the invention with a ceiling-height stowage cabinet.

FIG. 9 shows an exemplary embodiment of a fuselage segment according to the invention with a cargo region above a passenger region.

FIG. 10 shows an exemplary embodiment of a fuselage segment according to the invention, which comprises only one cargo region.

FIG. 11 shows an exemplary embodiment of a fuselage segment according to the invention with three passenger floors and an almost circular fuselage cross section.

FIG. 12 shows an exemplary embodiment of a fuselage segment according to the invention with three passenger floors and an almost circular fuselage cross section.

FIG. 13 shows an exemplary embodiment of a fuselage segment according to the invention with three passenger floors and an oval fuselage cross section.

FIG. 14 shows an exemplary embodiment of a fuselage segment according to the invention with three passenger floors and an oval fuselage cross section.

### DETAILED DESCRIPTION

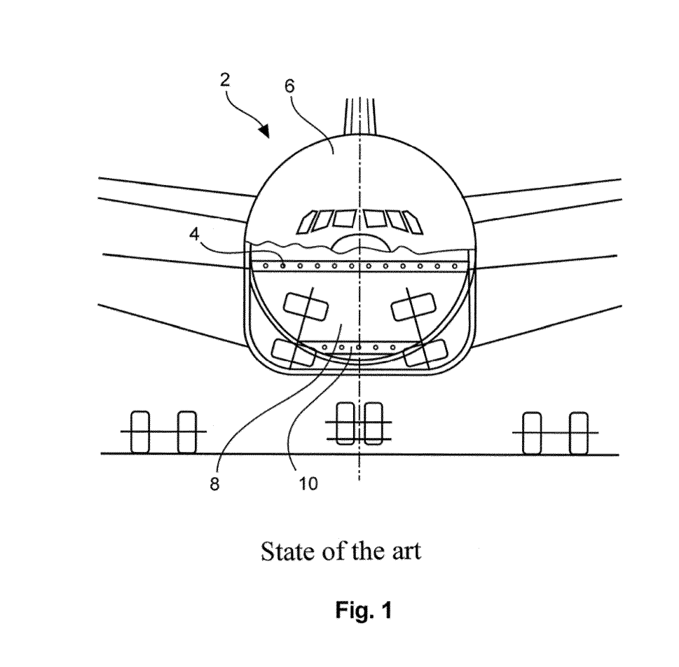

In a usual commercial aircraft as shown in FIG. 1 a fuselage 2 comprises a cabin floor 4 which towards the top partitions a passenger region 6 and towards the bottom partitions a cargo region 8. The cargo region 8 comprises a cargo hold floor 10 on which, for example, standardized cargo containers, items of baggage or the like can be stowed. The quantity of baggage of all passengers taken together comprises a defined volume that needs to be accommodated in the cargo region 8. This cargo region 8 is usually designed in such a manner that a very large quantity of baggage as well as cargo containers (not shown) can be accommodated. The ratio of numbers of passengers per m³ of cargo volume approximately ranges from 2:1 to 3:1.

However, with the aircraft being used exclusively for the transport of passengers, the provided cargo hold volume is not fully utilized so that the spare cargo hold volume is usually filled with containers or other items of cargo in order to achieve particularly economical operation of the aircraft.

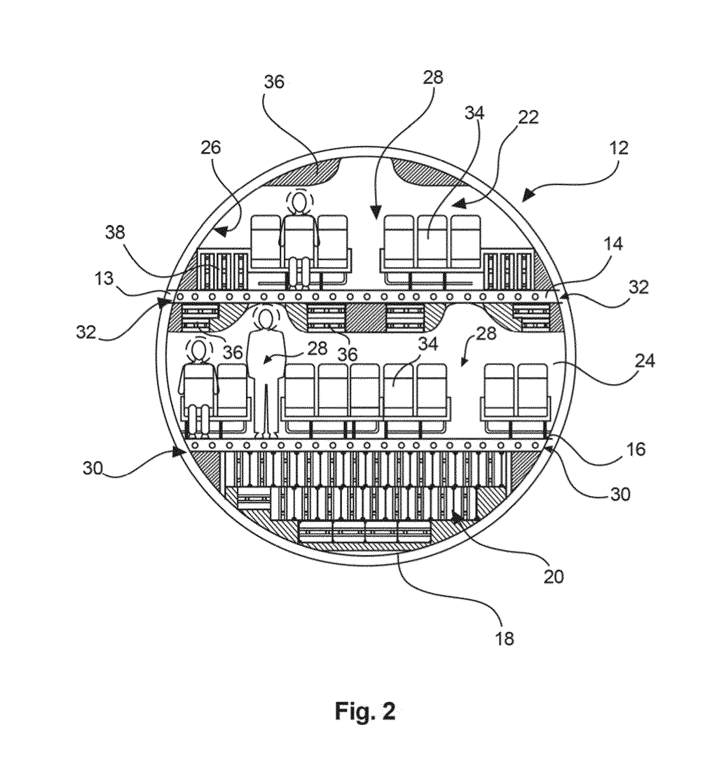

In contrast to the above, FIG. 2 shows a particularly advantageous design of a fuselage segment 12 that comprises an almost circular cross section. This fuselage segment 12 comprises a first cabin floor 14 and a second cabin floor 16, spaced apart in vertical direction from the aforesaid and situated underneath the aforesaid, as well as a cargo hold floor 18, arranged underneath the second cabin floor 16. The floors 14 and 16 each comprise a connection region 30 and 32 to the wall 13 where they are rigidly connected to the wall 13.

The fuselage segment 12 according to an embodiment of the invention is designed to provide space-optimized passenger transport; in other words the cargo region 20 delimited between the second cabin floor 16 and the cargo hold floor 18 provides just sufficient space for accommodating items of baggage which on average are taken by passengers on medium-range and long-range flights. In this manner the volume of the cargo region 20 overall can be dimensioned so as to be significantly smaller than is the case in conventional fuselage segments of medium-range and long-range aircraft from the state of the art. In this arrangement at least four passenger seats from a first passenger region 22 and a second passenger region 24 share 1 m³ cargo hold volume for items of baggage.

The design of the fuselage segment 12 is based on several boundary conditions. Firstly, it is necessary for passengers to be seated comfortably without having to assume a posture that is uncomfortable in the long term. This relates in particular to the edge regions near an interior wall 26 of the fuselage segment 12 according to the invention, so that in the first passenger region 22 the respective outer seats are spaced apart from the interior wall 26 by a relatively large space to prevent passengers from bumping their heads against the interior wall 26.

A further boundary condition in the design of the fuselage segment 12 according to an embodiment of the invention consists of maintaining a cabin height of at least 1.95 m or some similarly advantageous cabin height.

A further boundary condition relates to the general design of the cabin and the aisles situated therein, because according to a certification requirement a seat must be separated from an aisle by no more than two further seats. This means that in a passenger cabin comprising two aisles a maximum of 12 seats can be arranged. If more seats are possible because of the horizontal extension of the passenger cabin, at least one further aisle would also have to be arranged therein.

In a fuselage diameter ranging from 6 m to 6.50 m, which is thus in the region of the AIRBUS A350®, BOEING 777, MD11 or other aircraft of similar size, accordingly the variant with two passenger regions 22 and 24, shown in FIG. 2, would be possible, wherein the first passenger region 22 comprises one aisle 28, and the second passenger region 24 comprises two aisles 28. The first passenger region 22 is thus able to accommodate six seats 34 in a row, while, for example, the second passenger region 24 would be sufficient to be able to provide nine passenger seats 34.

Above the individual seats 34, overhead stowage compartments 36 can be arranged that are used for accommodating cabin baggage. However, since in the first passenger region 22, due to the quite considerable curvature of the interior wall 26, at the floor there is a relatively large space between the outer seats 34 and the interior wall 26, this region can be used for accommodating additional stowage compartments 38. From the adjacent seats 34 these stowage compartments 38 can comfortably be filled with items of cabin baggage, and at the same time can be used from the directly adjacent seats 34 as a temporary repository for personal effects or, for example, for a tray.

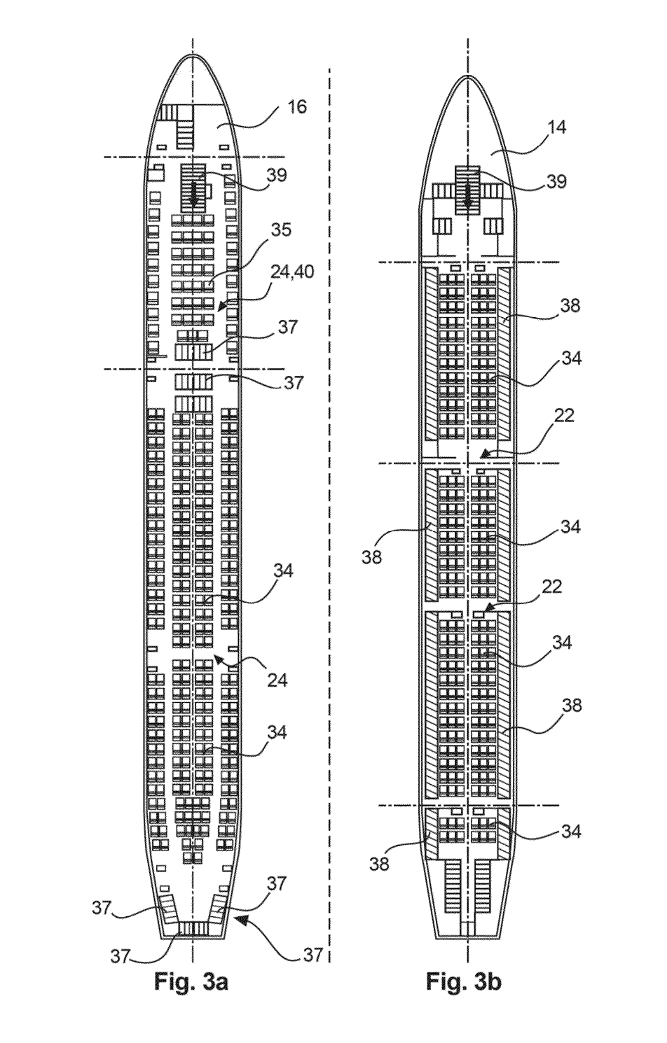

Based on FIG. 2, FIGS. 3a and 3b show a possible layout of the first passenger region 22 and of the second passenger region 24. In this arrangement FIG. 3a shows a top view of a longitudinal section of the lower, second, passenger region 22, while FIG. 3b shows a top view of a longitudinal section of the upper, first, passenger region 22. As an additional design the second passenger region 24 in a front section has a business class compartment that comprises a row of wider seats 35.

Apart from the arrangement of five passenger seats 34 arranged side by side in the center region, and two laterally arranged passenger seats 34 in the second passenger region and three laterally arranged seats 34 in the first passenger region 22, which arrangement is already shown in FIG. 2, corresponding options of positioning galleys 37 and stairs 39 are also shown. Preferably, the galleys 37 are arranged in a rear region, which faces the tail, of the fuselage, while preferably for spatial separation it is also possible for galleys 37 to be arranged between the business class region and the regions with conventional seats 34.

FIG. 3b shows the arrangement of lateral stowage compartments 38 on the upper, first, cabin floor 14, which stowage compartments 38 extend parallel to the longitudinal axis of the first cabin floor and are preferably positioned between all the laterally arranged passenger seats 34 and the interior wall 26 of the cabin. Attachment could preferably take place on seat rails comprising grids by means of conventional fastening means, which seat rails are used for passenger seats or the like. With this special arrangement, for arranging cabin baggage in the first passenger region 22 only that installation space is used which due to the proximity to the interior wall 26 cannot be used anyway for accommodating passengers.

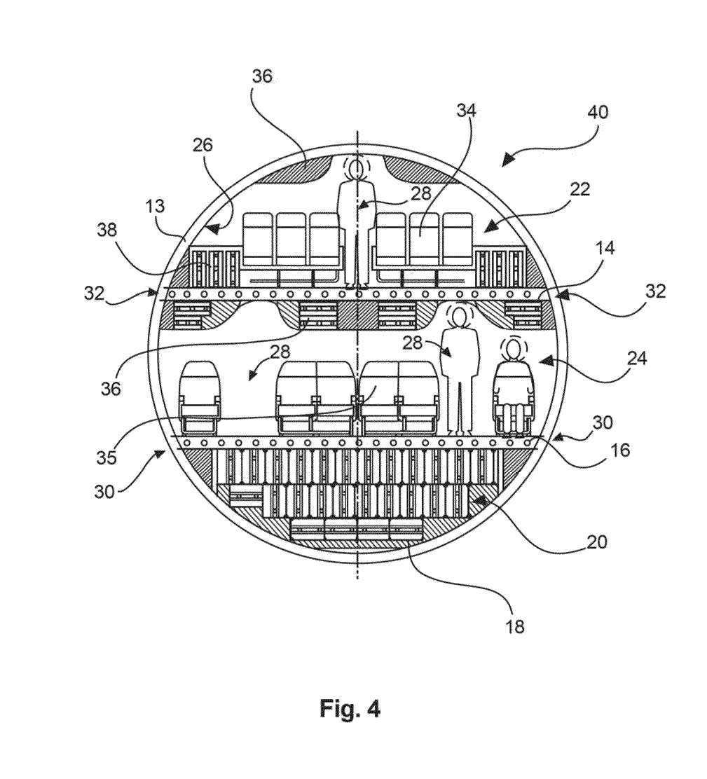

FIG. 4 shows a fuselage segment 40 according to an embodiment of the invention as a slight variation of the illustration of FIG. 2. The essential differences consist of the passenger seats on the second cabin floor 16 being designed as somewhat wider and more comfortable business class seats 35, while FIG. 2 exclusively shows economy class seats 34. The illustration of FIG. 4 could thus depict a front region of an aircraft fuselage shown in FIG. 3a.

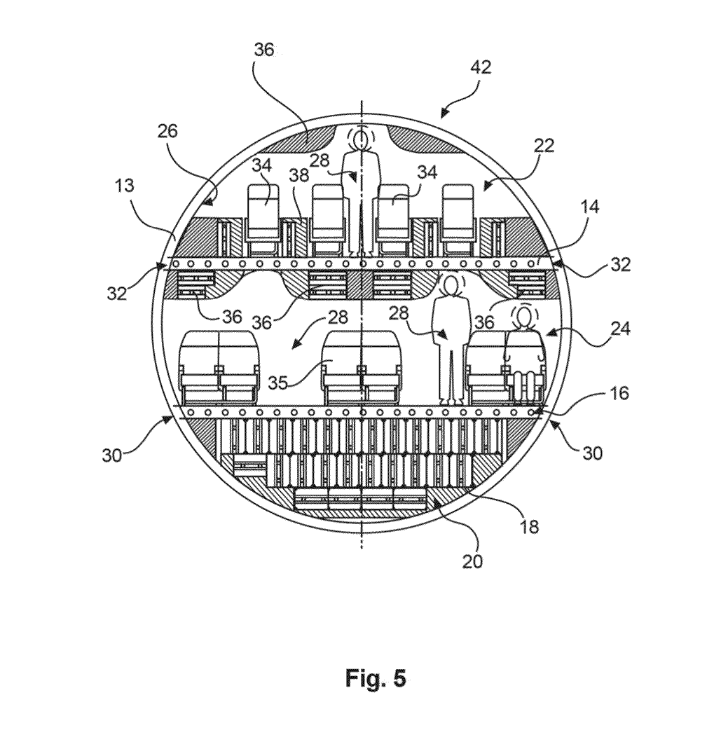

FIG. 5 shows a fuselage segment 42 according to an embodiment of the invention as a slight variation of the arrangement of FIG. 4 in that on the first cabin floor 14 the individual seats 34 are spaced slightly further apart from each other, and between them an aisle 28 or a stowage compartment 38 is arranged. As an example, on the second cabin floor 16 the same number of business class seats 35 as in FIG. 4 is used; albeit with two laterally arranged groups of seats 35 to which the aisles 28 adjoin, between which also only two seats 35 are arranged.

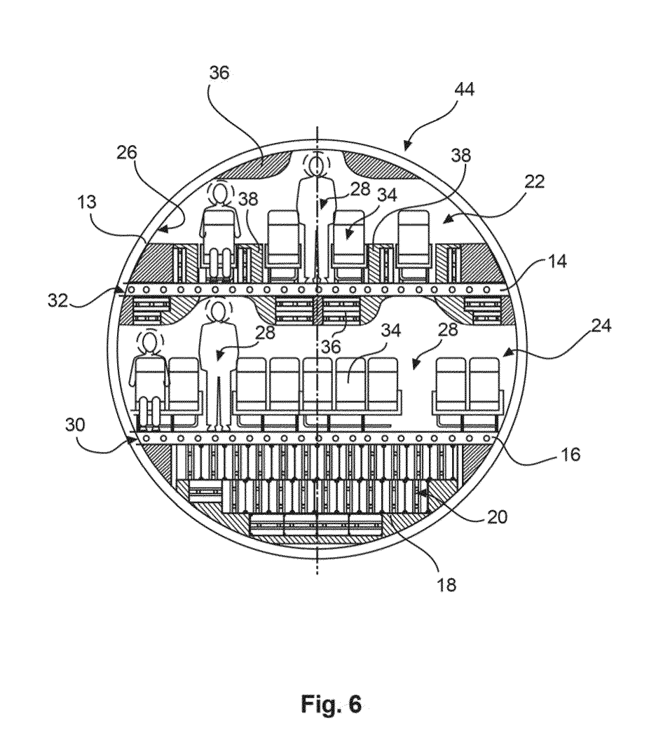

The fuselage segment 44 according to an embodiment of the invention, which fuselage segment 44 is shown in FIG. 6, is a variation of the fuselage segment 42 according to the invention as shown in FIG. 5 and on the second cabin floor 14 exclusively comprises economy class seats 34, wherein the design of the fuselage segment 44 remains unchanged per se.

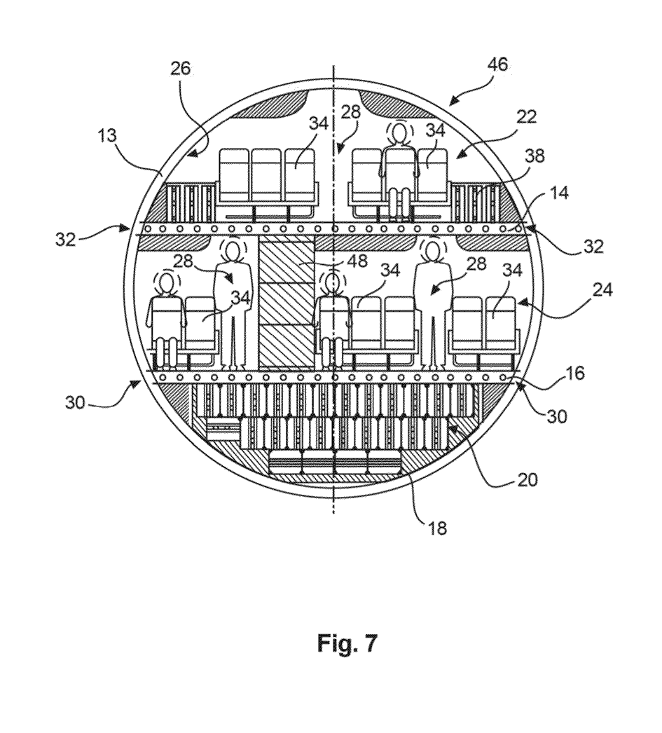

FIG. 7 shows a fuselage segment 46 according to an embodiment of the invention, in which fuselage segment 46 on the first cabin floor 14 a total of six economy class seats 34 are arranged, and on the second cabin floor 16 a total of seven passenger seats are arranged. In addition to this, a cabinet system which could, for example, be designed as a cabinet monument 48 arranged on the second cabin floor 16 is arranged in the second passenger region 24. The cabinet monument 48 is used to stow cabin baggage of the passengers in the second passenger region 24, so that the cabin height as the distance between the second cabin floor 16 and the first cabin floor 14 can be somewhat reduced because of the elimination of overhead stowage compartments. This could also make it possible in aircraft of a smaller fuselage diameter to integrate a second cabin floor 16 and thus make it possible to provide a second passenger region 24.

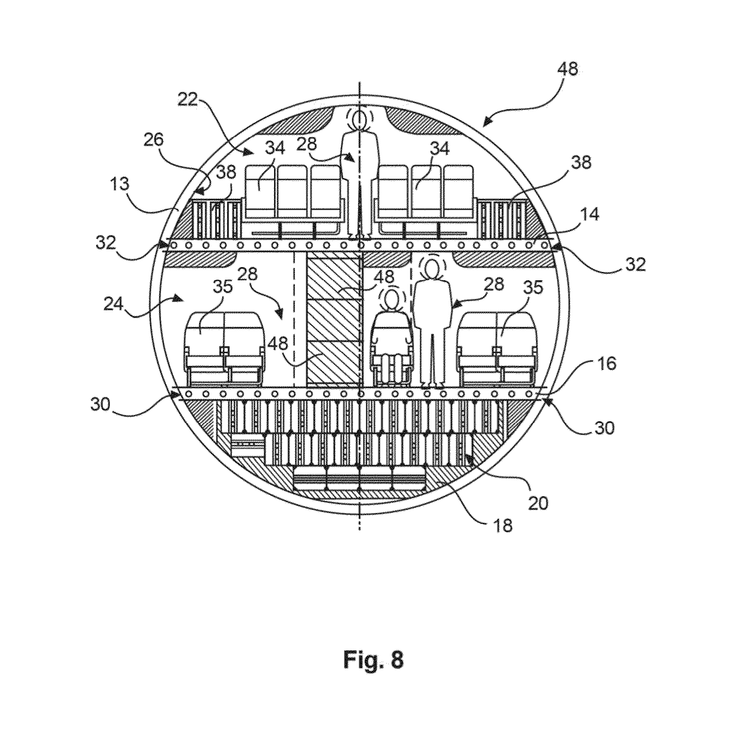

FIG. 8 shows a further variation of this in the form of a fuselage segment 50 according to an embodiment of the invention, in which fuselage segment 50 on the second cabin floor 16 apart from a cabinet monument 48 exclusively business class seats 35 are arranged. As a result of the alternating arrangement of two laterally arranged seats 35, an adjoining aisle 28, an adjacent cabinet monument 48, and a group comprising a seat 35, an aisle 28 and two further seats 35, overall only one seat fewer is provided than is the case in the second passenger region 24 of FIG. 5, wherein the entire passenger capacity can nevertheless be increased by arranging a total of six seats 34 in the first passenger region 22 situated above.

At this point it should be mentioned that the cabinet monuments 48 of FIGS. 7 and 8, which cabinet monuments 48 are located off-center, need not be arranged in this identical asymmetric position over the entire length of the cabin, but instead, could also be arranged in an alternating manner on the right-hand side or on the left-hand side of a symmetry axis of the second cabin floor 16.

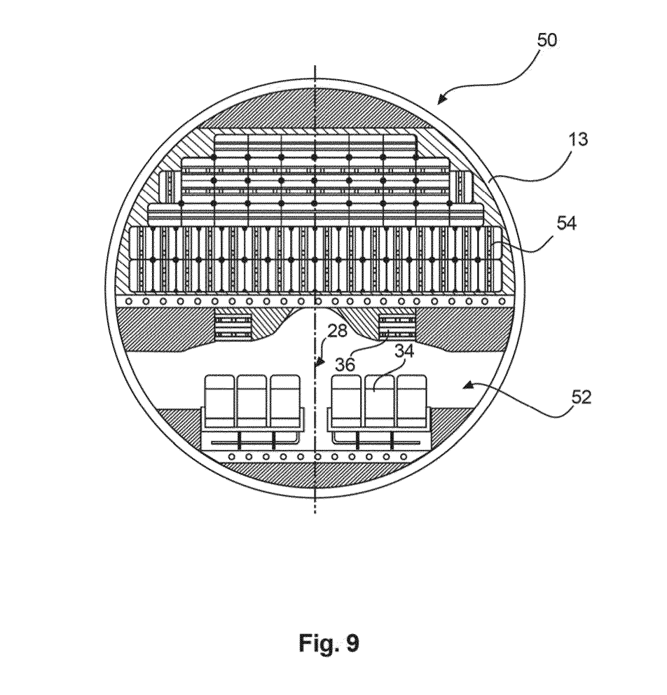

In those regions of the fuselage of an aircraft where the integration of a second cabin floor 16 may not necessarily make sense, be it as a result of a locally generally reducing fuselage cross section of a diameter of substantially less than 6 m, for example in the tail region of the aircraft, or as a result of available space that is relatively confined because of systems requiring installation space, in some regions it is also possible to arrange a single cabin floor. A fuselage segment, as shown in FIG. 9, comprises only a single passenger region 52 that is located in the lower half of the cross section. The remaining part situated above it could be completely taken up by a cargo region 54. In this manner the use of the existing limited installation space is optimized.

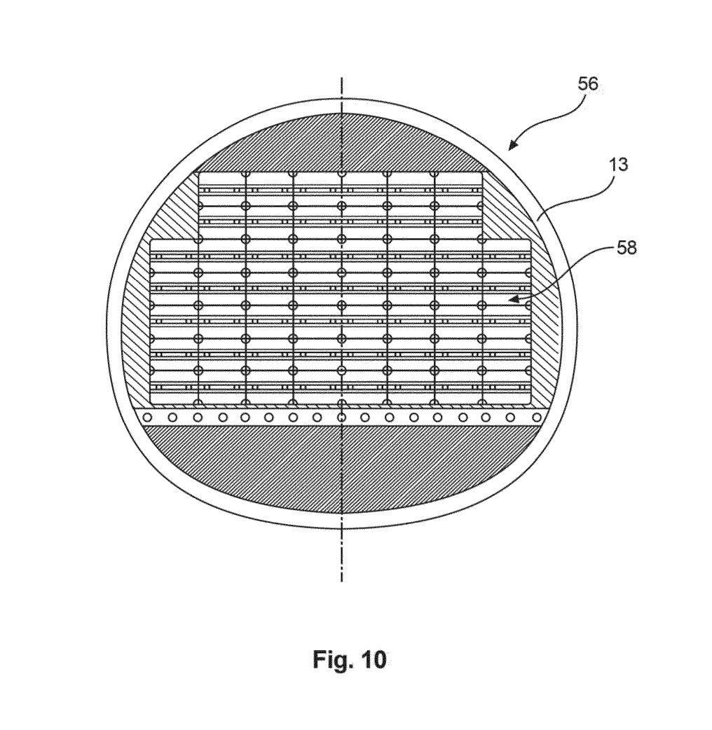

FIG. 10 shows a further possible fuselage segment 56 that exclusively comprises a cargo region 58 and could therefore particularly preferably be arranged in the tail cone.

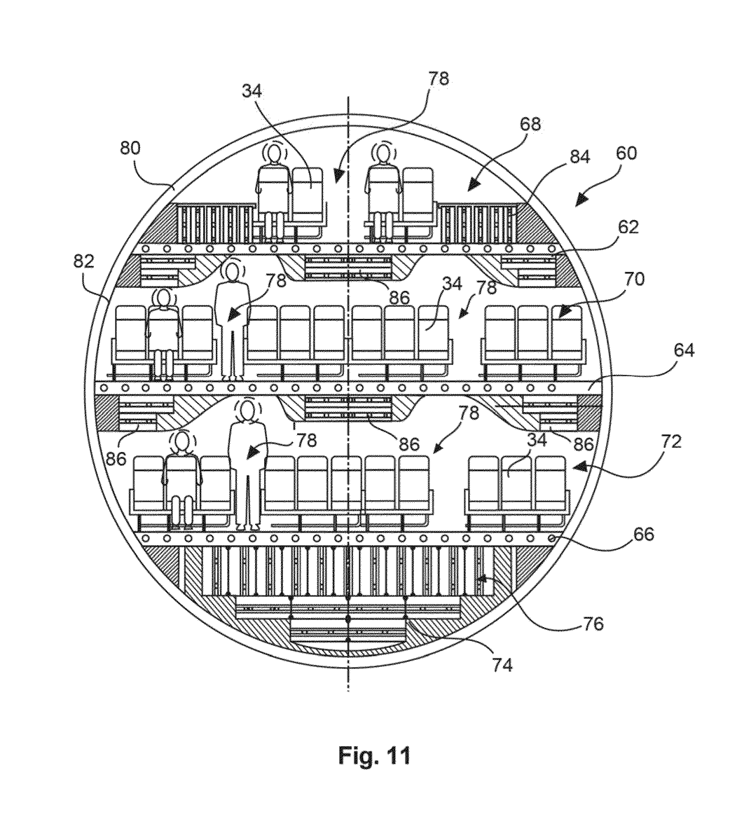

FIG. 11 shows a further variation of the fuselage segment 60 according to an embodiment of the invention, which has an essentially circular shape and comprises a first cabin floor 62, a second cabin floor 64 arranged underneath it, and a third cabin floor 66 arranged still further underneath it, which cabin floors are connected to a wall 80 of the fuselage segment 60 according to an embodiment of the invention. Consequently a first passenger region 68, a second passenger region 70, and a third passenger region 72 are obtained. Underneath the third passenger region 72 there is a cargo hold floor 74 that is delimited towards the top by the third cabin floor 66. The cargo region 76 formed in this manner is designed to be able to accommodate the average baggage of the passengers without having to provide excessive reserves.

As a result of the boundary conditions the three passenger regions 68, 70 and 72 are designed differently. Thus the second cabin floor 64, when viewed approximately vertically, is at half the height of the fuselage segment 60 according to an embodiment of the invention, thus providing a second passenger region 70 that can have the largest horizontal extension. This manifests itself in the maximum seating density in a fuselage segment 60 comprising two aisles 78, because the second passenger region 70 can accommodate a total of 12 passenger seats 34. The laterally arranged passenger seats 34 provide sufficient space for passengers, because the tangent of the interior lining 82 is still relatively steep in this region and deviates from vertical by only a few degrees.

As already shown in FIG. 2, it makes sense to arrange stowage compartments 84 in the top passenger region 68, which stowage compartments 84 are situated between the interior lining 82 and the lateral passenger seats 34, because this space could not be used for passenger seats 34. While the top passenger region 68 shown in this example can provide adequate headroom as well as a minimum cabin height for reaching the respective passenger seat 34, nonetheless the cabin height provided is insufficient to provide overhead stowage compartments. However, this is possible in the second passenger region 70, where there is sufficient headroom over the aisles 78; however, overhead stowage compartments 86 that can accommodate cabin baggage of the passengers can be arranged over the passenger seats 34 themselves.

In the third passenger region 72, too, overhead stowage compartments 86 are arranged which provide adequate space outside the aisles 78 for the cabin baggage of the passengers seated in that region.

The cargo region 76 comprises a stepped cargo hold floor 74 that is adapted to the contour of the fuselage segment 60 according to an embodiment of the invention, and is just sufficient to carry the average quantity of checked baggage. Furthermore, the cargo region 76 comprises an overall cargo volume that corresponds at most to 1 m³ for at least four passengers.

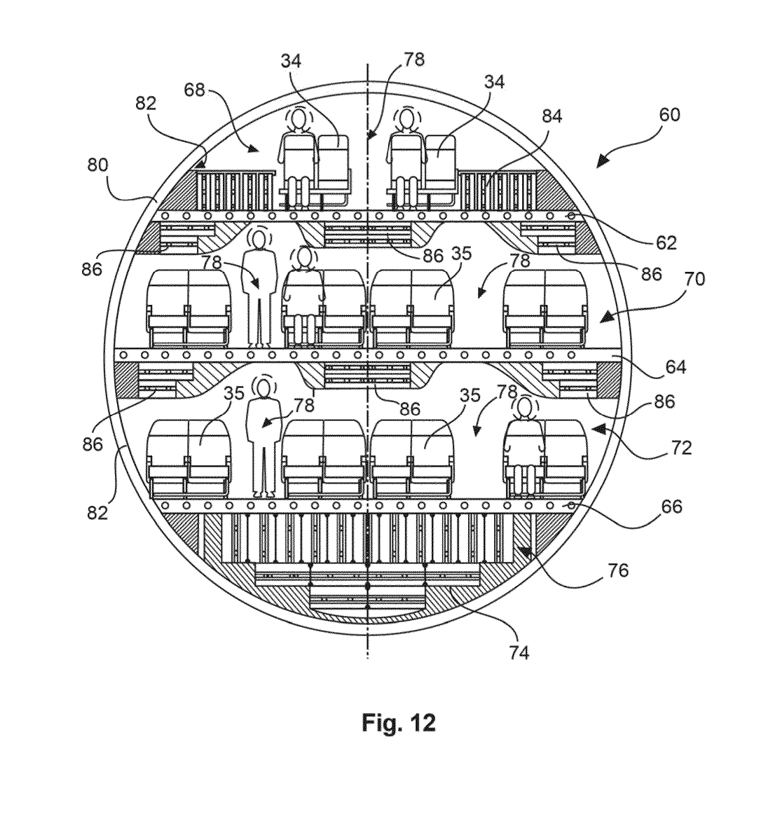

The variation in FIG. 12 shows a practically identical fuselage segment 60 according to an embodiment of the invention, which fuselage segment 60 is, however, designed to provide a higher level of passenger comfort and thus comprises somewhat more generously proportioned passenger seats. This changes the number of passenger seats in the horizontal extension so that the lowermost passenger region 72 comprises only eight passenger seats 35 instead of eleven seats 34. The same applies to the second passenger region 70, which is arranged above the aforesaid. In the example shown the first passenger region 68 is designed as an economy-passenger region so that in that region four conventional passenger seats 34 are arranged which provide a sufficient, but not excessive, amount of available space.

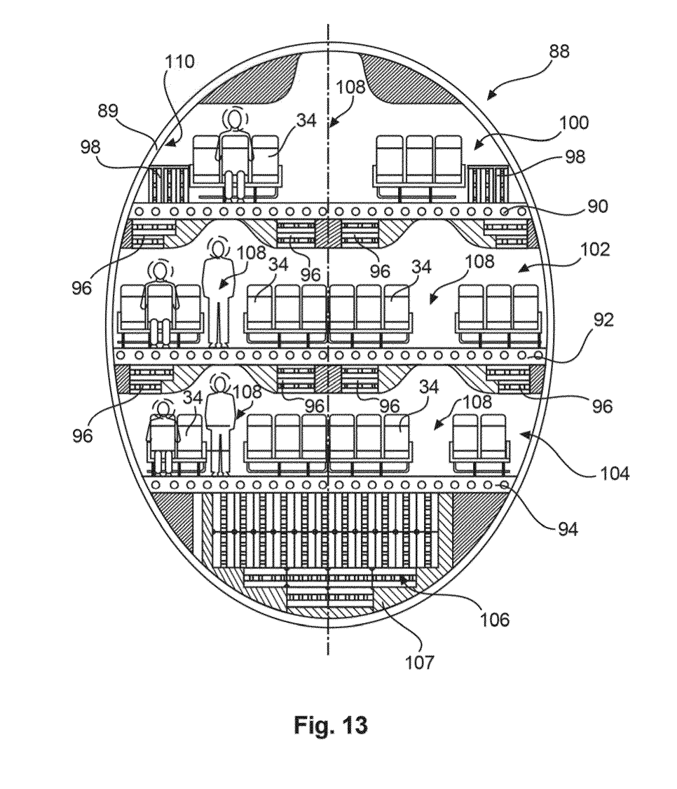

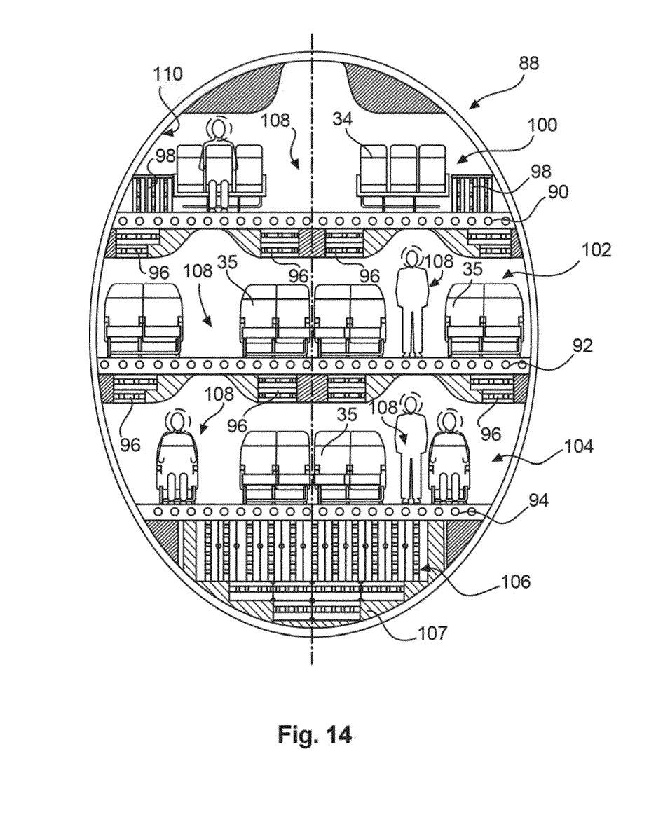

Finally, FIGS. 13 and 14 show a fuselage segment 88 according to an embodiment of the invention that comprises an oval cross section as provided, for example, in aircraft of the type AIRBUS A380®. This makes it possible to integrate a total of three passenger floors 90, 92 and 94. Since an oval fuselage comprises a relatively high fuselage height when compared to the fuselage width, reconfiguration of an oval fuselage would be possible relatively easily when compared to an almost circular fuselage.

FIG. 13 shows possible maximization of the absolute seat numbers, because the illustration exclusively shows economy class seats 34. A first, top, passenger region 100 in horizontal extension shows a total of six seats 34 that are divided by an aisle 108 into two groups, each comprising three seats 34. Between an interior wall 110 and the outermost seats 34 there are lateral stowage compartments 98 that can hold cabin baggage. Because of the curvature and the local inclination of the interior wall 110 the space taken up by the lateral stowage compartments 98 can anyway not be used for passenger seats 34.

A second passenger region 102, situated underneath said first passenger region 100, in horizontal extension comprises a total of twelve seats 34 and two aisles 108, which according to the usual regulations is the maximum number of seats 34 in the case of two aisles. If it was possible to accommodate a greater number of seats 34 in the second passenger region 102, at least one further aisle 108 would have to be provided. Overhead stowage compartments 96 that are arranged laterally of the aisles 108 and above seats 34 are used to accommodate cabin baggage.

Underneath the second passenger region 102, a third passenger region 104 is arranged which in horizontal extension can accommodate a total of ten seats 34, which are separated by two aisles 108.

At a lower section of the fuselage segment 88 according to the invention, a cargo region 106, which is designed in a demand-oriented manner, is arranged above a cargo hold floor 107.

FIG. 14 shows another seating variant of the fuselage segment 88 according to an embodiment of the invention, in which variant apart from the integration of economy class seats 34 in a top, first, passenger region 100 there are also two passenger regions 102 and 104 comprising business class seats 35. This seat arrangement could be provided throughout or only in some sections within an aircraft fuselage.

For example, the illustration shows a total of eight wider seats 35 in the second passenger region 102 and six wider seats 35 in a third passenger region 104, wherein these two passenger regions 102 and 104 as an example each comprise two aisles 108.

In addition, it should be pointed out that “comprising” does not exclude other elements or steps, and “a” or “one” does not exclude a plural number. Furthermore, it should be pointed out that characteristics which have been described with reference to one of the above exemplary embodiments can also be used in combination with other characteristics of other exemplary embodiments described above. Reference characters in the claims are not to be interpreted as limitations.

1. A fuselage segment for an aircraft fuselage, comprising
a wall with a closed cross section,
a first cabin floor,
a second cabin floor, and
a cargo hold floor,
wherein the first cabin floor, the second cabin floor and the cargo hold floor are vertically spaced apart from each other and connected to the wall,
wherein a first passenger region is arranged above the first cabin floor, wherein a second passenger region is arranged above the second cabin floor, and wherein at least one cargo region is arranged above the cargo hold floor,
wherein the cargo region is dimensioned in such a manner that for at least four passenger seats a maximum of 1 m³ of cargo hold volume is provided.

2. The fuselage segment of claim 1, wherein the total volume of the cargo region is less than the volume that corresponds to the maximum volume of baggage relating to all passenger seats.

3. The fuselage segment of claim 1, wherein the fuselage segment comprises a diameter ranging from 6 to 6.5 m.

4. The fuselage segment of claim 1, wherein each passenger region comprises a standing height of at least 1.95 m.

5. The fuselage segment of claim 1, wherein the first passenger region is arranged in an upper region of the fuselage segment and comprises lateral stowage compartments for accommodating cabin baggage, which stowage compartments are arranged between the outer passenger seats and a fuselage inner wall.

6. The fuselage segment of claim 1, wherein the cross section of the fuselage segment is configured to be almost circular.

7. The fuselage segment of claim 6, wherein the cross section of the fuselage segment corresponds to the cross section of a fuselage segment of an AIRBUS A350 aircraft.

8. The fuselage segment of claim 1, wherein the cross section of the fuselage segment is configured to be oval.

9. The fuselage segment of claim 8, wherein the cross section of the fuselage segment corresponds to the cross section of a fuselage segment of an AIRBUS A380 aircraft.

10. The fuselage segment of claim 1, comprising a third cabin floor delimiting a third passenger region.

11. The fuselage segment of claim 10, wherein the fuselage segment is configured to be almost circular and comprises a diameter of 7.25 to 7.75 m.

12. The fuselage segment of claim 10, wherein the fuselage segment is oval and comprises a width ranging from 6.5 m to 7.25 m.

13. The fuselage segment of claim 1,
wherein at least one passenger region comprises at least one stowage cabinet arranged on a cabin floor, and
wherein the at least one passenger region does not comprise any overhead stowage compartments.

14. An aircraft fuselage comprising at least one fuselage segment, the at least one fuselage segment comprising:
a wall with a closed cross section,
a first cabin floor,
a second cabin floor, and
a cargo hold floor,
wherein the first cabin floor, the second cabin floor and the cargo hold floor are vertically spaced apart from each other and connected to the wall,
wherein a first passenger region is arranged above the first cabin floor, wherein a second passenger region is arranged above the second cabin floor, and wherein at least one cargo region is arranged above the cargo hold floor,
wherein the cargo region is dimensioned in such a manner that for at least four passenger seats a maximum of 1 m³ of cargo hold volume is provided.

15. An aircraft comprising an aircraft fuselage comprising at least one fuselage segment, the at least one fuselage segment comprising:
a wall with a closed cross section,
a first cabin floor,
a second cabin floor, and
a cargo hold floor,
wherein the first cabin floor, the second cabin floor and the cargo hold floor are vertically spaced apart from each other and connected to the wall,
wherein a first passenger region is arranged above the first cabin floor, wherein a second passenger region is arranged above the second cabin floor, and wherein at least one cargo region is arranged above the cargo hold floor,
wherein the cargo region is dimensioned in such a manner that for at least four passenger seats a maximum of 1 m³ of cargo hold volume is provided.
